(19) United States
(12) Patent Application Publication
(10) Pub. No.: US 2013/0162589 A1
(43) Pub. Date: Jun. 27, 2013

(54) HANDWRITING DEVICE WITH MAGNETIC RECHARGING SITE

(71) Applicants: CHIEN-CHIA LIEN, Hsin-Chu City (TW); CHIA-JUI YEH, Taipei City (TW)

(72) Inventors: CHIEN-CHIA LIEN, Hsin-Chu City (TW); CHIA-JUI YEH, Taipei City (TW)

(21) Appl. No.: 13/564,926

(22) Filed: Aug. 2, 2012

(30) Foreign Application Priority Data
Dec. 23, 2011 (TW) 100148474

(51) Int. Cl. G06F 3/046

(52) U.S. Cl. 345/174

(57) ABSTRACT

A handwriting device with a magnetic recharging site is disclosed. The handwriting device comprises a tablet with a magnetic recharging site and an electromagnetic pen with a magnet. The electromagnetic pen includes a coil for transmitting electromagnetic signals, a magnetic permeable material inside the coil, charging electrodes, a super capacitor or a battery and a first magnet. The tablet has a handwriting area, a pen's recharging socket, charging electrodes, a charging circuit and a second magnet. The recharging site is located adjacent the handwriting area for accommodating the electromagnetic pen, and the charging electrodes connect to the charging circuit of the tablet which can provide electrical power to the magnetic electromagnetic pen. The first and second magnets are used to mount the electromagnetic pen on the pen recharging socket through the magnetic force along a correct direction.

### FIELD OF THE INVENTION

The present invention relates to a handwriting device, and more particularly to a handwriting device with a magnetic recharging site as well as an electromagnetic pen with a magnet.

### DESCRIPTION OF THE PRIOR ART

Electromagnetic type handwriting input devices such as tablets, digitizers utilize principles of operation with a circuit board having a plurality of antennas or sensor coils arranged along x or y axes and an electromagnetic pen which can emit electromagnetic signals so as to perform input operation. Current electromagnetic type handwriting input devices can be categorized as handwriting input devices using electromagnetic pens including batteries and handwriting input devices using batteryless electromagnetic pens depending on the electromagnetic pens utilized for input operation. The electromagnetic input technique utilized by the electromagnetic type handwriting input devices using electromagnetic pens including batteries is known as an active electromagnetic input technique. The handwriting input devices utilizing the active electromagnetic input technique do not need to transmit excess energy to the electromagnetic pen since the electromagnetic pen used which includes an electric power source can emit electromagnetic signals itself, and the handwriting input devices receive the electromagnetic signals from the electromagnetic pen. The major disadvantage of the active electromagnetic input technique is the extra weight added resulting from the battery. The electromagnetic input technique utilized by the electromagnetic type handwriting input devices using electromagnetic pens without batteries is known as a passive electromagnetic input technique. The handwriting input device needs to provides an energy source to the electromagnetic pen since the electromagnetic pen does not use any battery. The handwriting input device utilizes the antennas or sensor coils for receiving electromagnetic signals to transmit energy to the electromagnetic pen. The operation of the handwriting input device is to use the antennas or sensor coils adjacent the electromagnetic pen to transmit dozens of cycles of electromagnetic energy to the electromagnetic pen once the electromagnetic pen is detected. Then the handwriting input device stops transmitting electromagnetic energy and starts to receive the electromagnetic signals from the electromagnetic pen through the antennas or sensor coils. Since the energy of the electromagnetic pen will be dissipated quickly, and the electromagnetic signals transmitted to the handwriting input device can only endure for dozens of cycles, the handwriting input device must transmit electromagnetic energy again and enter the next cycle of transmitting and receiving. Since the cycle of energy transmitting and signal receiving must be repeated continually, the performance of the passive electromagnetic input technique is worst than that of the active electromagnetic input technique.

For the convenience of user to use or retrieve the electromagnetic pen, the handwriting input device must have a site, socket or space for accommodate the electromagnetic pen whether the electromagnetic pen is with a battery or not. For the handwriting input device which uses the electromagnetic pen with batteries or super capacitors, a recharge site for the electromagnetic pen is needed to recharge the electromagnetic pen. Thus the invention provides a handwriting device with a magnetic recharging site and an electromagnetic pen with a magnet to meet the above-mentioned requirement.

### SUMMARY OF THE INVENTION

An object of the present invention is to integrate a recharge site and an electromagnetic pen socket into a tablet so that the table can have functions of accommodating and recharging the electromagnetic pen at the same time.

According to the object, one embodiment of the present invention provides a handwriting device with a magnetic recharging site. The handwriting device comprises a tablet with a magnetic recharging site and an electromagnetic pen with a magnet. The electromagnetic pen includes a coil for transmitting electromagnetic signals, a magnetic permeable material inside the coil, charging electrodes, a super capacitor or a battery and a first magnet. The tablet has a handwriting area, a pen recharging socket, charging electrodes, a charging circuit and a second magnet. The recharging site with the pen recharging socket is located adjacent the handwriting area for accommodating the electromagnetic pen, and the charging electrodes connect to the charging circuit of the tablet which can provide electrical power to the magnetic electromagnetic pen. The first and second magnets are used to mount the electromagnetic pen on the pen recharging socket along a correct direction through the attractive magnetic force between the first and second magnets. And the pen cannot be charged if the pen is improperly placed.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A shows a tablet 100 with a magnetic recharging site according to one embodiment of the invention.

FIG. 1B shows a schematic view of an electromagnetic pen 200 placed on the tablet 100 with a magnetic recharging site to initiate recharging according to one embodiment of the invention.

FIG. 1C shows a schematic view of normal placement and recharging of the tablet 100 and the electromagnetic pen 200 of the handwriting input device according to one embodiment of the invention.

FIG. 1D shows a schematic view of abnormal placement and the electromagnetic pen 200 cannot be charged by the tablet 100 according to one embodiment of the invention.

FIG. 1E shows a cross-sectional view of the recharging site of the tablet 100 according to one embodiment of the invention.

FIG. 1F shows another embodiment of the recharging site of the tablet 100 of the invention.

FIG. 1G shows another embodiment of the pen recharging socket of the tablet of the invention.

FIG. 1H shows a cross-sectional view of the recharging site of the tablet according to another embodiment of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

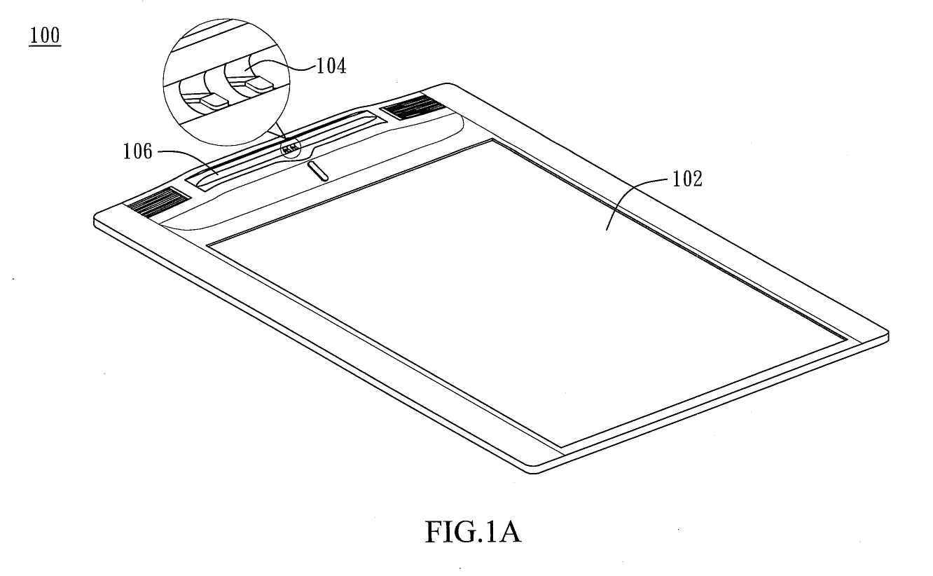

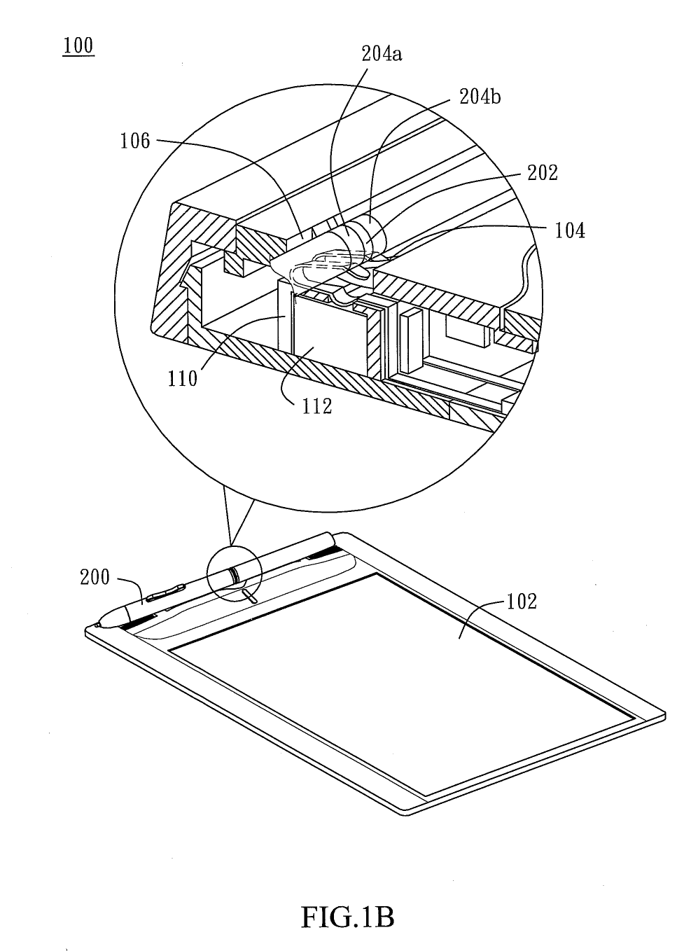

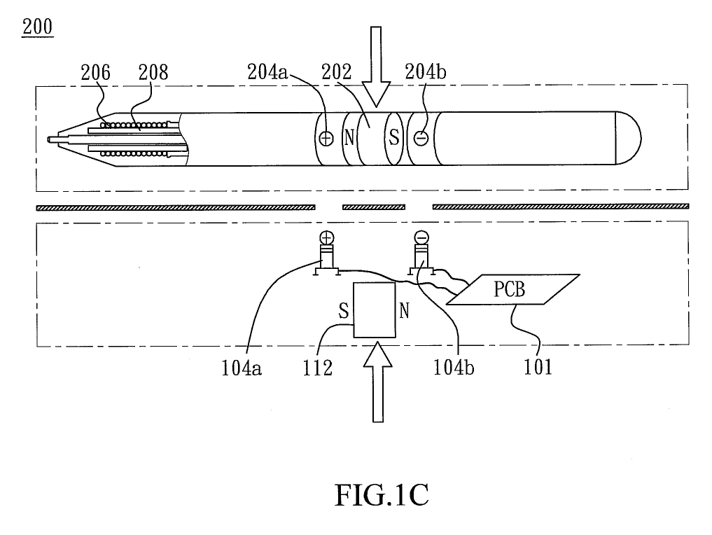

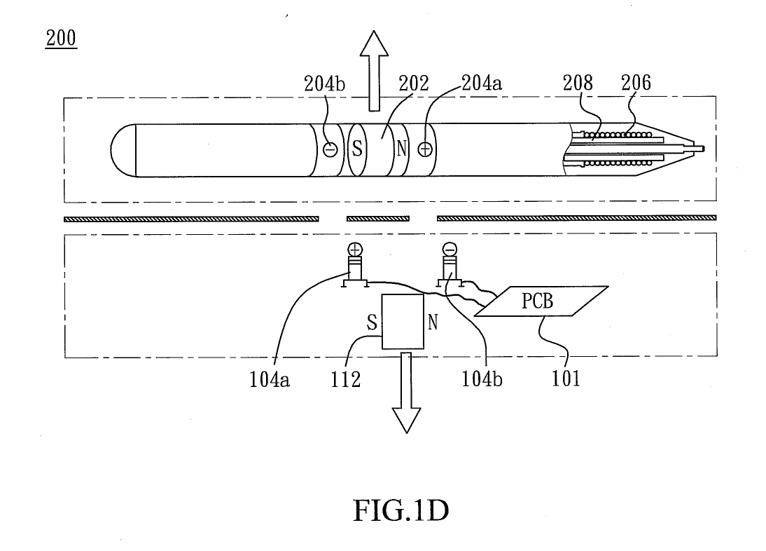

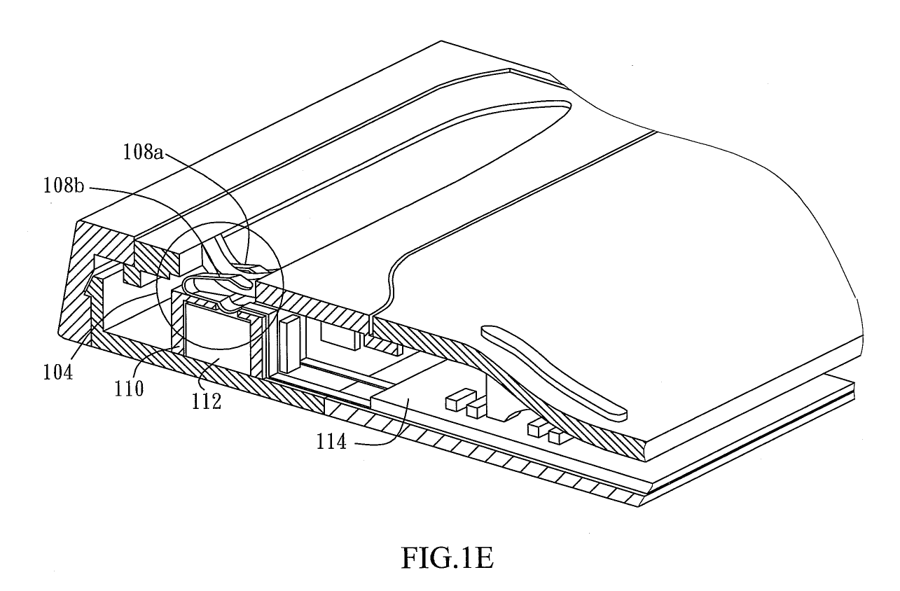

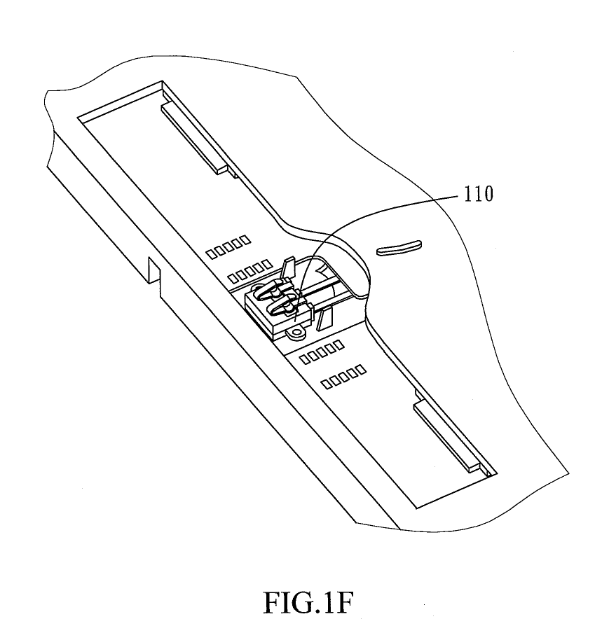

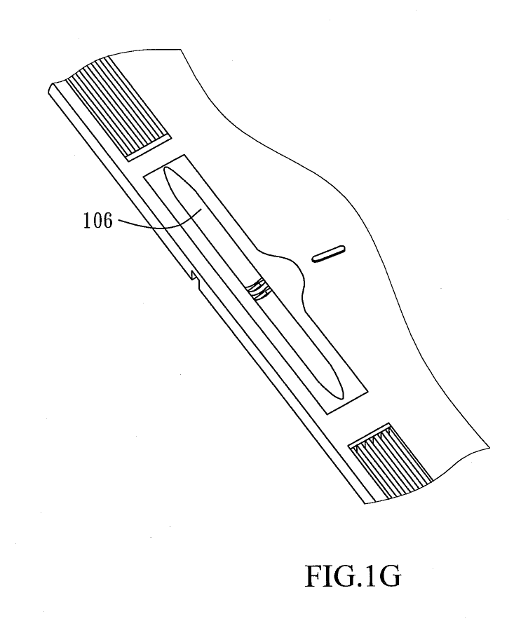

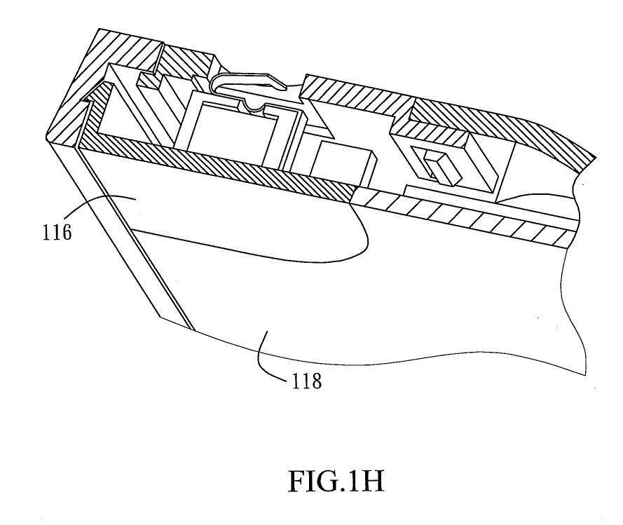

FIG. 1A shows a tablet 100 with a magnetic recharging site according to one embodiment of the invention. The tablet 100 with a magnetic recharging site includes a handwriting area 102, charging electrodes 104 and a pen recharging socket 106. In this embodiment, as shown in FIG. 1B, an electromagnetic pen including a magnet and a super capacitor or a rechargeable battery is used with the tablet 100. The electromagnetic pen with a super capacitor or a rechargeable battery is placed on the pen recharging socket 106 to recharge the electromagnetic pen, with charging electrodes 104 electrically connecting to recharging electrodes 204a and 204b of the electromagnetic pen, when the electromagnetic pen needs to be charged. The tablet 100 also includes a control circuit, a signal processing circuit and an antenna board having a plurality of antenna loops thereon, etc. since the detail of the circuit design of the tablet and the arrangement of the super capacitor or the battery are not crucial features of the invention, these features will not be particularly described herein.

FIG. 1B shows a schematic view of an electromagnetic pen 200 placed on the tablet 100 with a magnetic recharging site to initiate recharging according to one embodiment of the invention. As shown in FIG. 1B, when the electromagnetic pen 200 needs to be recharged, the electromagnetic pen 200 is placed on the pen recharging socket 106 of the tablet 100 to recharge the electromagnetic pen 200, through the attracting magnetic force between a magnet 112 in a magnet mount 110 of the recharging site and a magnet 202 located between the recharging electrodes 204a and 204b of the electromagnetic pen 200, the recharging electrodes 204a and 204b of the electromagnetic pen 200 contact and attach to the charging electrodes 104 of the tablet 100 with a correct alignment direction.

FIG. 1C shows a schematic view of normal recharging of the tablet 100 and the electromagnetic pen 200 of the handwriting input device according to one embodiment of the invention. FIG. 1C also shows an electromagnetic pen of one embodiment of the invention. The electromagnetic pen 200 includes the magnet 202 and the recharging electrodes 204a and 204b so as to attach to the magnet mount 110 of the recharging site and initiate recharging. Although the magnet 202 is located between the recharging electrodes 204a and 204b in the embodiment shown in FIGS. 1C and 1D, the magnet 202 is not limited to locate between the recharging electrodes 204a and 204b. The tablet 100 has a circuit 101 including a recharging circuit to provide the electromagnetic pen 200 with charging electrical power on a printed circuit board. The charging electrodes 104 of the tablet 100 comprises charging contacts 104a and 104b so as to contact and connect with the recharging electrodes 204a and 204b of the electromagnetic pen 200. The tablet 100 further includes the magnet 112 so as to attach and mount the electromagnetic pen 200 on the recharging site of the tablet 100 through the magnetic force between the magnet 202 of the electromagnetic pen 200 and the magnet 112. The location of the magnet 202 should match the positions of the magnet mount 110 and the magnet 112 of the tablet 100. The electromagnetic pen 200 includes a coil 206 and a magnetic permeable material 208 in the coil 206. The coil 206 is for transmitting electromagnetic signals while the magnetic permeable material 208 in the coil 206 is for increasing the strength of the electromagnetic signals. The magnetic permeable material 208 comprises a ferrite core.

The attractive and repulsive force of a magnet is strongest at the north and south poles. These poles attract the opposite polarity (positive attracts negative, and vice versa), and repel the same polarity. As shown in FIG. 1C, since the recharging electrodes 204a and 204b of the electromagnetic pen 200 as well as the charging contacts 104a and 104b of the tablet 100 both include an anode and a cathode respectively, in one embodiment, the magnet 112 of the recharging site and the magnet 202 of the electromagnetic pen 200 are arranged via the attractive characteristic of the opposite magnetic poles to keep the proper polarity connection between the recharging electrodes 204a and 204b and the charging contacts 104a and 104b. The recharging circuit of the circuit 101 can provide the electromagnetic pen 200 with charging electrical power through the connection between the recharging electrodes 204a and 204b of the electromagnetic pen 200 and the charging contacts 104a and 104b of the tablet 100.

Opposite poles attract, like poles repel. FIG. 1D shows a schematic view of abnormal placement of the tablet 100 and the electromagnetic pen 200 of the handwriting input device according to one embodiment of the invention. As shown in FIG. 1D, when the electromagnetic pen 200 is improperly placed on the recharging site, the recharging electrodes 204a and 204b and the charging contacts 104a and 104b cannot maintain its contact and connection because of the repulsive characteristic of the same magnetic poles between the magnet 112 of the recharging site and the magnet 202 of the electromagnetic pen 200. The structure of the recharging site of the tablet 100 will be further described with FIG. 1E.

FIG. 1E shows a cross-sectional view of the recharging site of the tablet 100 according to one embodiment of the invention. As shown in FIG. 1E, the charging contacts 104a and 104b of the charging electrodes 104 of the tablet 100 comprise, but not limited to plate spring contacts 108a and 108b to connect with the recharging electrodes 204a and 204b of the electromagnetic pen 200. The plate spring contacts 108a and 108b connect to a recharging circuit on a printed circuit board 114 so as to provide the recharging electrical power to the electromagnetic pen 200. The tablet 100 provides electrical power through the charging electrodes 104, and the recharging circuit of the tablet 100 can be any suitable recharging circuit.

When the electromagnetic pen 200 is placed on the pen recharging socket 106 of the recharging site of the tablet 100, because of the attractive characteristic of the magnetic poles between the magnet 112 of the recharging site and the magnet 202 of the electromagnetic pen 200, the recharging electrodes 204a and 204b and the plate spring contacts 108a and 108b can maintain stable connection along the correct direction. The magnet 112 is located under the plate spring contacts 108a and 108b corresponding to the magnet 202 of the electromagnetic pen 200 so that the electromagnetic pen 200 can be attached and mounted on the pen recharging socket 106 of the recharging site of the tablet 100. The magnet 112 is mounted on a bottom plate of the tablet 100 through the magnet mount 110.

FIG. 1F shows another embodiment of the recharging site of the tablet 100 of the invention. As shown in FIG. 1F, the magnet mount 110′ of the recharging site, the magnet and the plate spring contacts are interchangeable parts. FIG. 1G shows another embodiment of the pen recharging socket of the tablet of the invention. As shown in FIG. 1G, the pen recharging socket is an interchangeable part. The pen recharging socket can be replaced with an electromagnetic pen socket 106′ for accommodating an electromagnetic pen without a battery. Since the electromagnetic pen does not use a battery as power source and utilize electromagnetic signals emitted from the tablet as power source, the electromagnetic pen does not need to be charged and the charging electrodes are not necessary for the tablet to connect with the batteryless electromagnetic pen.

FIG. 1H shows a cross-sectional view of the recharging site of the tablet according to another embodiment of the invention. As shown in FIG. 1H, the bottom plate 118 of the tablet 100 comprises a metal bottom plate. In order to prevent interference from the metal bottom plate on the magnet in the magnet mount, the bottom plate 118 includes a non-metal portion 116 under the magnet mount and the magnet to support the magnet mount and the magnet.

According to the above-mentioned detailed description and figures, it is quite clear that the handwriting device comprising a tablet with a magnetic recharging site and an electromagnetic pen with a power source can provide a user with a recharging capability of the electromagnetic pen. When the electromagnetic pen needs to be recharged, the electromagnetic pen can be mounted and recharged on the recharge site of the tablet through the attracting magnetic force between a magnet of the tablet and a magnet of the electromagnetic pen and the electrical connection between the charging electrodes of the tablet and the recharging electrodes of the electromagnetic pen. If the electromagnetic pen used with the tablet is a batteryless electromagnetic pen, the recharge site of the tablet can be replaced with an electromagnetic pen socket for accommodating an electromagnetic pen without a battery or a super capacitor so that the batteryless electromagnetic pen can be mounted on the tablet via the magnets while the batteryless electromagnetic pen is not in use. Although the above-mentioned embodiments use tablet as examples, the invention can also be applied to the fields related to the invention.

Although specific embodiments have been illustrated and described, it will be appreciated by those skilled in the art that various modifications may be made without departing from the scope of the present invention, which is intended to be limited solely by the appended claims.

What is claimed is:

1. A handwriting input device with a magnetic recharging site comprising:
an electromagnetic pen including a first magnet; and
a tablet with a magnetic recharging site, comprising
a pen recharging socket, the recharging socket accommodating the electromagnetic pen;
two charging contacts, the charging contacts connecting to a recharging circuit of the tablet to provide the electromagnetic pen with an electrical power; and
a second magnet, wherein the electromagnetic pen can be mounted on the pen recharging socket with a correct alignment direction through an attracting magnetic force between the second magnet and the first magnet.

2. The handwriting input device according to claim 1, wherein the electromagnetic pen comprises a super capacitor or a rechargeable battery as a power source, a coil and a magnetic permeable material in the coil.

3. The handwriting input device according to claim 1, wherein the charging contacts comprise plate spring contacts.

4. The handwriting input device according to claim 1, wherein the electromagnetic pen comprises two recharging electrodes to connect with the charging contacts.

5. The handwriting input device according to claim 1, wherein the second magnet is mounted by a magnet mount so that the second magnet is aligned between the charging contacts when the electromagnetic pen is mounted on the pen recharging socket with a correct alignment direction

6. The handwriting input device according to claim 1, wherein the tablet includes a metal bottom plate, the metal bottom plate includes a non-metal portion under the second magnet to support the second magnet.

7. The handwriting input device according to claim 1, wherein the pen recharging socket is an interchangeable part, and can be replaced with an electromagnetic pen socket for accommodating a batteryless electromagnetic pen.

8. The handwriting input device according to claim 4, wherein the first magnet is located between the recharging electrodes.

9. The handwriting input device according to claim 5, wherein the magnet mount, the second magnet and the charging contacts are interchangeable parts.

10. The handwriting input device according to claim 7, wherein the electromagnetic pen comprises a batteryless electromagnetic pen.
